(19) United States
(12) Patent Application Publication
(10) Pub. No.: US 2003/0047194 A1
(43) Pub. Date: Mar. 13, 2003

(54) Apparatus and method for cleaning wafers

(76) Inventors: Lung Hui Tsai, Kaohsiung (TW); Su-Ling Tseng, Hsinchu (TW); Chuan-Ju Chuang, Hsinchu (TW)

Correspondence Address: BIRCH STEWART KOLASCH & BIRCH, PO BOX 747, FALLS CHURCH, VA, 22040-0747, US

(21) Appl. No.: 09/949,714

(22) Filed: Sep. 12, 2001

(51) Int. Cl. B08B 1/04

(52) U.S. Cl. 134/6; 15/77; 15/88.2; 15/102; 134/18

(57) ABSTRACT

An apparatus and a method for cleaning wafers are provided. The apparatus for cleaning wafers comprises a first arm, a second arm, a water-supplying device, a measuring device, a transmitting device, and a brushing device. The water-supplying device supplies water to the wafer through the second arm to clean the wafer. The measuring device continuously measures the electrical properties of the water, after cleaning the wafer, and outputs a first signal. The transmitting device receives the first signal and outputs a second signal to the water-supplying device to continue cleaning the wafer when the first signal does not reach a set value and outputs a third signal to the water-supplying device to cease cleaning when the first signal reaches a set value. The brushing device, disposed on the first arm, brushes the wafer when the water is supplied to the wafer. By measuring the electrical properties of the water after cleaning, the invention directly monitors the cleanliness of the wafer. As a result, under- and over-cleaning are avoided, and economic value is optimized.

### BACKGROUND OF THE INVENTION

1. Field of the Invention

The invention relates to an apparatus and a method for cleaning wafers; in particular, the invention relates to a wafer-cleaning apparatus and method that directly monitors the cleanliness of the wafer in-line by measuring the electrical properties of the water after cleaning the wafer.

2. Description of the Related Art

In ultra large scale integration (ULSI) process, for example, before wafers enter a high-temperature chamber or after wafers are subjected to thin-film etching, the wafers must be subjected to chemical cleaning, de-ionized (DI) water rinsing and drying so the surface of the wafer can attain the requirement of high cleanliness. Wafer-cleaning technique affects the yield, the quality of the device and the reliability. Wafer cleaning removes contamination on the surface of the wafer, such as particles, organic and metal ions.

The wafer-cleaning technique comprises a wet chemical cleaning and a physical cleaning technology. No matter which procedure is used, a step in which DI water sprays or cleans the wafer is included.

Traditionally, the cleanliness of the wafer is controlled by time. That is, the DI water sprays or cleans the wafer within a set time. Thus, under- or over-cleaning may occur. Under-cleaning can affect the wafer's ability to attain the standard value of cleanliness, and over-leaning incurs unnecessary costs.

### SUMMARY OF THE INVENTION

In order to address the disadvantages of the aforementioned wafer-cleaning technique, the invention provides an apparatus and method for cleaning wafers that directly monitors the cleanliness of the wafer in-line by continuously measuring the electrical properties of the water after cleaning the wafer.

Accordingly, the invention provides an apparatus for cleaning wafers comprising a first arm, a second arm, a water-supplying device, a measuring device, a transmitting device, and a brushing device. The DI water-supplying device delivers water needed to clean the wafer through the second arm. The measuring device continuously measures the electrical properties of the water, after cleaning, and outputs a first signal. The transmitting device receives the first signal and outputs a second signal to the water-supplying device to continue cleaning the wafer when the first signal does not reach a set value, and outputs a third signal to the water-supplying device to cease cleaning when the first signal reaches a set value. The brushing device, disposed on the first arm, brushes the wafer when the water is applied.

The apparatus further comprises a sprayer, disposed on the second arm, which communicates with the water-supplying device.

The apparatus further comprises a nozzle, an oscillator and a controller. The nozzle, disposed on the second arm, communicates with the water-supplying device. The oscillator, disposed on the second arm, communicates with the nozzle. The controller is electrically connected to the oscillator.

The invention also provides a method for cleaning wafers comprising the following steps. First, the wafer is cleaned by water, then the electrical properties of the water, after cleaning, are continuously measured. Wafer cleaning continues when the electric properties do not reach a set value and the wafer cleaning is terminated when the electric properties reach a set value.

The method further comprises a step in which the wafer is brushed by a brushing device while the water cleans the wafer.

### BRIEF DESCRIPTION OF THE DRAWINGS

The invention is hereinafter described in detail with reference to the accompanying drawings in which:

FIG. 1 is a schematic view depicting a first embodiment of an apparatus for cleaning wafers as disclosed in the invention;

FIG. 2 is a schematic view depicting the inner portion of the apparatus for cleaning wafers as disclosed in the invention;

FIG. 3 is a flow chart depicting a method for cleaning wafers as disclosed in the invention; and

FIG. 4 is a schematic view depicting a second embodiment of an apparatus for cleaning wafers as disclosed in the invention.

### DETAILED DESCRIPTION OF THE INVENTION

First Embodiment

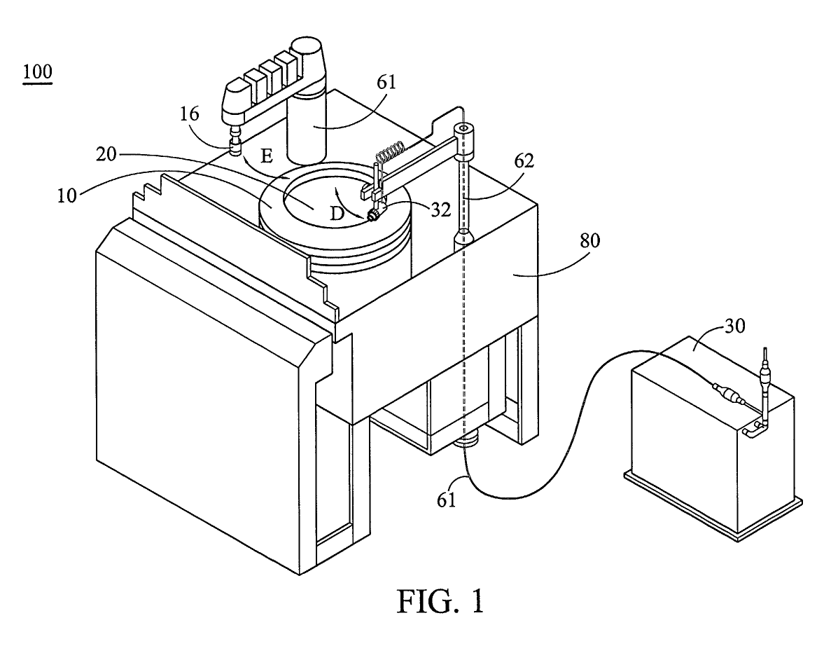

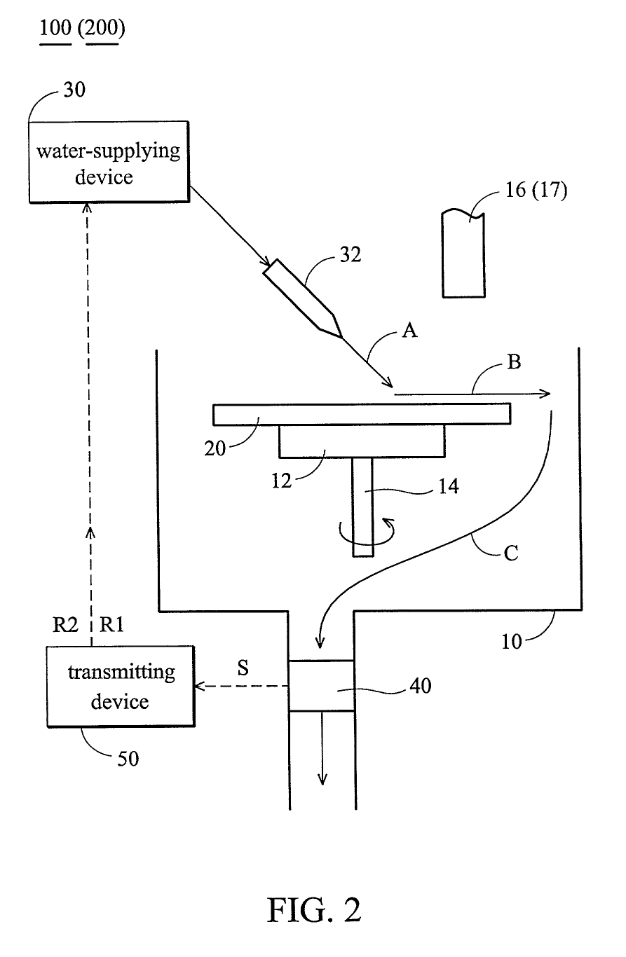

In FIG. 1 and FIG. 2, a first embodiment of an apparatus 100 for cleaning wafers as disclosed in the invention is shown. FIG. 1 is a schematic view depicting a first embodiment of an apparatus for cleaning wafers as disclosed in the invention, and FIG. 2 is a schematic view depicting the inner portion of an apparatus for cleaning wafers as disclosed in the invention.

As shown in FIG. 1 and FIG. 2, numeral 80 represents a base. Parts of the apparatus 100 can be disposed inside the base 80. A bath 10 is disposed inside the base 80. A vacuum chuck 12 and a rotary shaft 14, connected to the vacuum chuck 12, are disposed inside the bath 10. A wafer 20 can be disposed on the vacuum chuck 12. The wafer 20, disposed on the vacuum chuck 12, rotates at high speed by the action of the rotary shaft 14.

A first arm 61 and a second arm 62 are disposed inside the base 80. A brushing device 16 is disposed at the front end of the first arm 61, and can swing along a direction, as shown by arrow E. The brushing device 16 contacts the wafer 20 disposed on the vacuum chuck 12 and brushes the surface. A step motor, an adjustable spring mechanism and a cylinder (not shown), disposed inside the first arm 61 and electrically connected to the brushing device 16, move and rotate the brushing device 16.

A sprayer 32 is disposed at the front end of the second arm 62. A step motor (not shown), disposed inside the second arm 62, rotates the second arm 62 and the sprayer 32 along a direction, as shown by arrow D.

A water-supplying device 30 supplies DI water to the sprayer 32 and sprays in a direction, as shown by arrow A and arrow B, to clean the surface of the wafer 20. In the bath 10, the wafer 20, rotating at high speed, is sprayed and brushed simultaneously.

As shown in FIG. 2, the apparatus 100 of this embodiment comprises the water-supplying device 30, a measuring device 40 and a transmitting device 50. The measuring device 40 is disposed below the bath 10. The water, after cleaning the wafer 20, advances in a direction, as shown by arrow C, flows out of the bath 10 and passes through the measuring device 40. The measuring device 40 continuously measures the electrical properties of the water, after cleaning, and outputs a first signal S. The transmitting device 50 receives the first signal S. The transmitting device 50 outputs a second signal R1 to the water-supplying device 30 to continue cleaning the wafer 20 when the first signal S does not reach a set value. The transmitting device 50 outputs a third signal R2 to the water-supplying device 30 to cease cleaning when the first signal S reaches a set value.

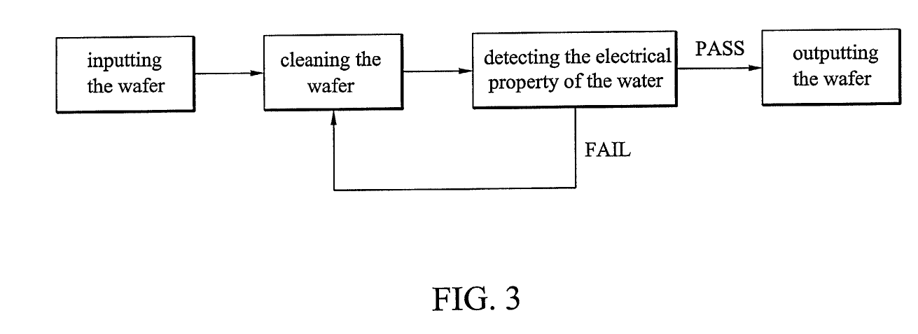

FIG. 3 is a flow chart depicting a method for cleaning wafers according to this embodiment. First, the wafer 20 is placed on the vacuum chuck 12 and is cleaned by the water. Then, the electrical properties of the water, after cleaning the wafer 20, are continuously measured. When the electric properties do not reach a set value, the wafer-cleaning process advances along a direction, as shown by the “FAIL” arrow, and continues. When the measurement reaches a set value, the wafer-cleaning process advances along a direction, as shown by the “PASS” arrow, and ceases.

The basic principle of this embodiment is that water with different contaminant levels exhibits different electrical properties. The electrical properties, adapted for the measuring device 40, are not limited as long as their value depends on the contaminant level of the water. For example, conductance or resistance can also be used as the electrical properties to be measured. Other electrical properties may also be used as the electrical properties to be measured.

This embodiment is a general procedure of a physical cleaning technology. Generally, the contaminated object to be removed is a particle. Since the concentration thereof included in the water changes the electrical properties of water, the set value stated above can depend on the amount of the particle. Thus, the cleanliness of the wafer may depend on the concentration of the particles.

In wet chemical cleaning, before the wafer is cleaned by the water, the wafer is cleaned by chemicals. The water removes the residual chemicals. According to similar theorem, water with different concentrations of the chemical exhibits different electrical properties. Thus, the set value stated above can depend on the concentration of the chemical in the water. Also, the cleanliness of the wafer may depend on the concentration of the chemical in the water.

According to the apparatus and the method of this embodiment, since the measuring device and the transmitting device are additionally disposed, the electrical properties of the water, after cleaning the wafer, can be continuously measured. The signal of the electrical properties can be transmitted to the water-supplying device, as feedback, to determine whether water supply is to be continued or not. As a result, this embodiment directly monitors the cleanliness of the wafer in-line. As well, under- and over-cleaning are avoided, and economic value is optimized.

Second Embodiment

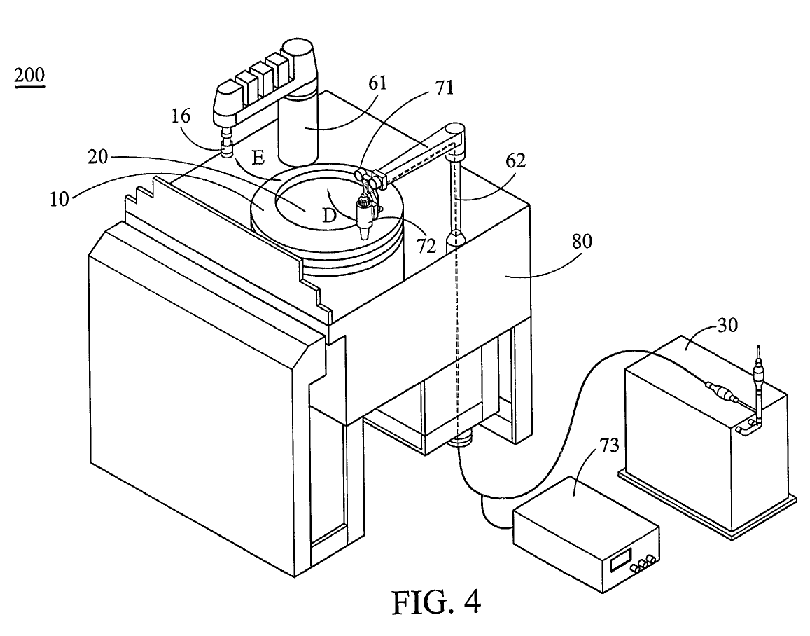

FIG. 4 is a schematic view depicting a second embodiment of an apparatus 200 for cleaning wafers as disclosed in the invention. In this embodiment, the apparatus 200 comprises a bath 10, a vacuum chuck 12, a rotary shaft 14, a brushing device 16, a water-supplying device 30, a measuring device 40, a transmitting device 50, a first arm 61, a second arm 62 and a base 80. Since the structure and the disposition of the above parts are the same as the first embodiment, their description is omitted and their marks are the same as the first embodiment.

The difference between this embodiment and the first embodiment is that the sprayer 32 of the first embodiment is replaced by an oscillator 71, a nozzle 72 and a controller 73.

The controller 73 excites the DI water molecules to provide ultrasonic cleaning when the DI water is supplied to the wafer 20. The oscillator 71, disposed at the second arm 62, is used as an oscillation-transmitting device between the nozzle 72 and the controller 73. The nozzle 72, disposed at the second arm 62, is electrically connected to the controller 73 via the oscillator 71 and communicates with the water-supplying device 30 and the oscillator 71.

By the above structure, the DI water, ejected from the nozzle 72, ultrasonically cleans the surface of the wafer 20. Since the other structure of this embodiment is the same as the first embodiment, the water, after cleaning the wafer 20, flows out of the bath 10 and passes through the measuring device 40. The measuring device 40 continuously measures the electrical properties of the water, after cleaning the wafer 20, and outputs a first signal S. The transmitting device 50 receives the first signal S. The transmitting device 50 outputs a second signal R1 to the water-supplying device 30 to continue cleaning the wafer 20 when the first signal S does not reach a set value. The transmitting device 50 outputs a third signal R2 to the water-supplying device 30 to cease cleaning when the first signal S reaches a set value.

Furthermore, the method for cleaning wafers of this embodiment is the same as the first embodiment, as shown in FIG. 3; therefore, their description is omitted.

As stated above, this embodiment can attain the same effect of the first embodiment.

While the invention has been particularly shown and described with reference to a preferred embodiment, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

What is claimed is:

1. An apparatus for cleaning wafers comprising:
a first arm and a second arm;
a water-supplying device for supplying water to the wafer through the second arm to clean the wafer;
a measuring device for continuously measuring the electrical properties of the water, after cleaning the wafer, and outputting a first signal;
a transmitting device for receiving the first signal and outputting a second signal to the water-supplying device to continue cleaning the wafer when the first signal does not reach a set value and outputting a third signal to the water-supplying device to cease cleaning when the first signal reaches a set value; and
a brushing device, disposed on the first arm, for brushing the wafer when the water is supplied on the wafer.

2. The apparatus as claimed in claim 1, further comprising:
a sprayer, disposed on the second arm, communicating with the water-supplying device.

3. The apparatus as claimed in claim 1, further comprising:
a nozzle, disposed on the second arm, communicating with the water-supplying device.

4. The apparatus as claimed in claim 3, further comprising:
an oscillator, disposed on the second arm, communicating with the nozzle;
a controller electrically connected to the oscillator.

5. The apparatus as claimed in claim 1, wherein the water is de-ionized water.

6. The apparatus as claimed in claim 1, wherein the electric property is conductance.

7. The apparatus as claimed in claim 1, wherein the electric property is resistance.

8. A method for cleaning wafers comprising:
cleaning the wafer with water;
continuously measuring the electrical properties of the water after cleaning the wafer; and
continuing to clean the wafer when the electric property does not reach a set value and ceasing cleaning when the electric property reaches a set value.

9. The method as claimed in claim 8, further comprising:
brushing the wafer by a brushing device when the water cleans the wafer.

10. The method as claimed in claim 8, wherein the water is de-ionized water.

11. The method as claimed in claim 8, wherein the electric property is conductance.

12. The method as claimed in claim 8, wherein the electric property is resistance.
